(19) United States
(12) Patent Application Publication
(10) Pub. No.: US 2021/0081155 A1
(43) Pub. Date: Mar. 18, 2021

(54) INFORMATION PROCESSING METHOD, PRINTING METHOD AND NON-TEMPORARY RECORDING MEDIUM

(71) Applicant: TOSHIBA TEC KABUSHIKI KAISHA, Tokyo (JP)

(72) Inventor: Daiki SAKAMOTO, Mishima Shizuoka (JP)

(73) Assignee: TOSHIBA TEC KABUSHIKI KAISHA, Tokyo (JP)

(21) Appl. No.: 16/574,730

(22) Filed: Sep. 18, 2019

(51) Int. Cl. G06F 3/12

(52) U.S. Cl. CPC G06F 3/1257; G06F 3/1204; G06F 3/1238; G06F 3/1222; G06F 3/1252

(57) ABSTRACT

An information processing method for providing transferable printing setting information is disclosed. The method may include two steps. In the first step, printing setting information used for printing data of a file is applied by an information-processing device and received in an image-forming device. In the second step, the printing setting information is recorded in a data area in the file having no influence to the original data in the file when the file is operated through an application. The recorded printing setting information may be transferred together with the original data when the file is transferred to another information processing device and may be applied to a different image forming apparatus to configure printing settings accordingly.

### FIELD

Embodiments described herein relate generally to an information processing method, a printing method, and a non-temporary recording medium.

### BACKGROUND

A user who performs printing may have a demand for printing according to a specific printing setting. Generally, the user needs to set a desired printing setting each time by operating his/her own information processing apparatus or the like. A technology is proposed to simplify such a setting operation each time. In office-related applications relating to a document editing, a table calculation or the like, a technology is proposed to be capable of storing only a part of basic items among a plurality of items in the printing setting in a file. For example, items directly relating to a layout on the application are used as storable items. As a specific example, such items may be items relating to a sheet size and sheet orientation.

However, the printing setting is required each time for items other than the items stored in the application. In particular, in a case in which a file is printed by different users or in different environments, it is necessary to newly set the printing setting used at the time of printing in advance. Particularly, such a problem occurs evidently at the time of printing through different printers.

As one of solutions to such a problem, there is a technology of exporting information relating to the printing setting to another file and managing such a file together with a file to be printed. However, such a technology is not desirable because exported files are always required, which increases burden in labor in terms of file management.

### DESCRIPTION OF THE DRAWINGS

FIG. 1 is a system configuration diagram illustrating an overall configuration of an information processing system according to an embodiment;

FIG. 2 is a block diagram illustrating a hardware configuration of an information processing apparatus 200;

FIG. 3 is a flowchart depicting a specific example of a flow of an operation at the time a printing setting is recorded by the information processing apparatus 200;

FIG. 4 is a flowchart depicting a specific example of a flow of an operation at the time printing is performed by the information processing apparatus 200; and

FIG. 5 is a diagram illustrating a specific example of printing setting information.

### DETAILED DESCRIPTION

In accordance with an embodiment, an information processing method includes two steps. In the first step, printing setting information used for printing data of a file is received. In the second step, the printing setting information is recorded in a data area in the file having no influence when the file is operated through an application.

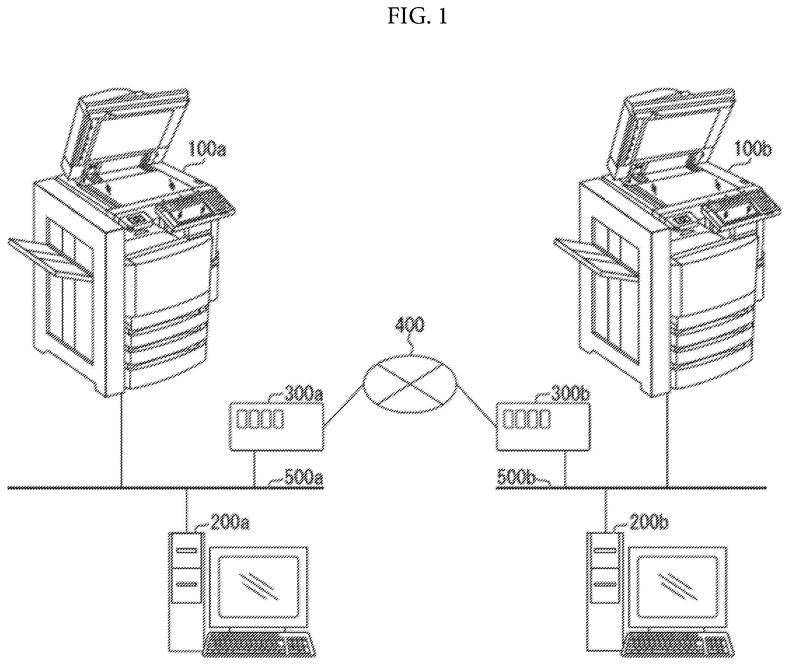

FIG. 1 is a system configuration diagram illustrating an overall configuration of an information processing system according to an embodiment. The information processing system of the embodiment includes a plurality of image forming apparatuses 100 (100a and 100b), a plurality of information processing apparatuses 200 (200a and 200b), a plurality of communication devices 300 (300a and 300b), and a network 400. The image forming apparatus 100a, the information processing apparatus 200a and the communication device 300a are connected to the same local network 500a. The image forming apparatus 100a and the information processing apparatus 200a can communicate with each other via the local network 500a. The information processing apparatus 200a and the communication device 300a can communicate with each other via the local network 500a. The information processing apparatus 200a can be connected to the network 400 via the communication device 300a. The information processing apparatus 200a can communicate with the information processing apparatus 200b connected to a local network 500b via the network 400.

The image forming apparatus 100b, the information processing apparatus 200b and the communication device 300b are connected to the same local network 500b. The image forming apparatus 100b and the information processing apparatus 200b can communicate with each other via the local network 500b. The information processing apparatus 200b and the communication device 300b can communicate with each other via the local network 500b. The information processing apparatus 200b can be connected to the network 400 via the communication device 300b. The information processing apparatus 200b can communicate with the information processing apparatus 200a connected to the local network 500a via the network 400.

The image forming apparatus 100 is a multi-function peripheral for printing an image containing characters and the like on a sheet. If an instruction to perform printing is received from the information processing apparatus 200, the image forming apparatus 100 prints an image indicated by the received instruction on the sheet. At this time, if information relating to a printing setting (hereinafter, referred to as “printing setting information”) is included, the printing is performed according to the printing setting information. The printing setting information may be set by, for example, a printer driver installed in the information processing apparatus 200. The printing setting information includes, for example, information indicating a size of a sheet to be printed, information indicating orientation of the sheet, information indicating whether monochrome printing or color printing will be performed, information indicating the number of pages printed on one sheet, information indicating whether or not duplex printing will be performed, information indicating the number of aggregated sheets, information indicating whether to perform printing specific to certain information, such as confidential information, and other types of information related to setting in a printing operation.

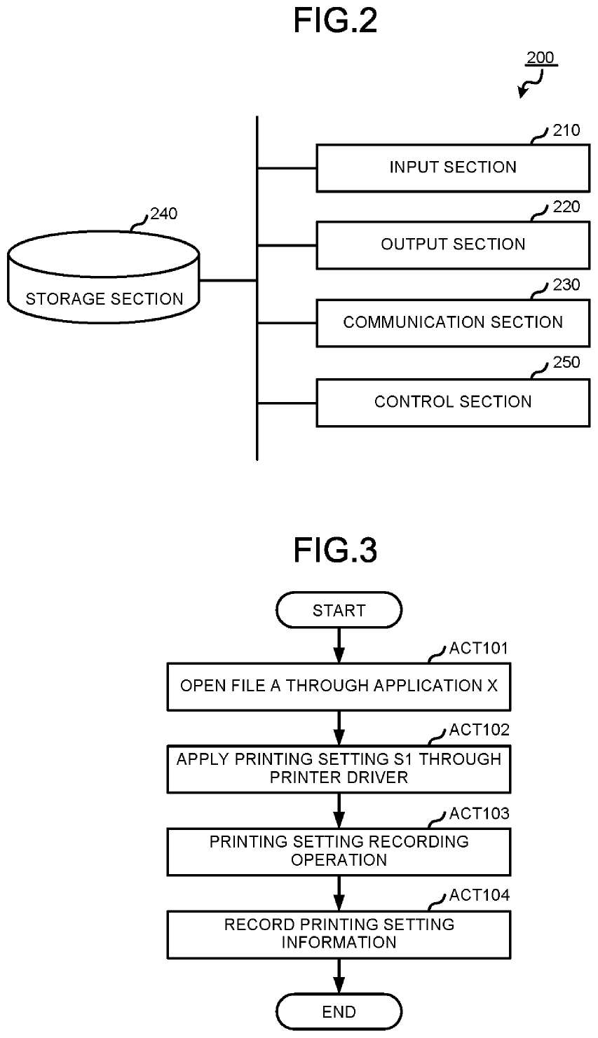

A printer driver corresponding to the image forming apparatus 100 can be installed in the information processing apparatus 200. The information processing apparatus 200 is, for example, a personal computer, a smartphone, a tablet, a server or the like. FIG. 2 is a block diagram illustrating a hardware configuration of the information processing apparatus 200. The information processing apparatus 200 includes an input section 210, an output section 220, a communication section 230, a storage section 240 and a control section 250.

The input section 210 is an existing input device such as a keyboard, a pointing device (e.g., mouse, tablet, or the like), a button, a touch panel, or the like. The input section 210 is operated by a user when an instruction from the user is input to the information processing apparatus 200. The input section 210 may be an interface for connecting an input device to the information processing apparatus 200. In this case, the input section 210 inputs an input signal generated in response to an input by the user in the input device to the information processing apparatus 200.

The output section 220 outputs data to a user of the information processing apparatus 200 via an output device (not shown) connected to the information processing apparatus 200. The output device may be, for example, a device that displays an image or characters on a screen. For example, the output device may be a CRT (Cathode Ray Tube), a liquid crystal display, an organic EL (Electro-Luminescent) display, or the like. The output device may be a device that converts characters into sound and outputs the sound. In this case, the output device may be a sound synthesizer and a sound output device (speaker).

The communication section 230 is a communication interface. The communication section 230 outputs communication data to the local network 500 under the control of the control section 250.

The storage section 240 is a storage device such as a magnetic hard disk device or a semiconductor storage device. The storage section 240 stores one or more application programs to be executed by the information processing apparatus 200. The application programs stored in the storage section 240 may be, for example, office-related applications such as a word processor application, a table calculation application, or an image editing application. The storage section 240 stores a printer driver corresponding to at least one image forming apparatus 100 to which the information processing apparatus 200 is connected in a communication enabled manner. The storage section 240 stores data of a file to be printed. The file to be printed is, for example, a file edited through an application program stored in the storage section 240.

The control section 250 includes a processor such as a CPU (Central Processing Unit) and a memory connected to each other via a bus. The control section 250 executes an application program stored in the storage section 240 in response to the operation performed by the user. The control section 250 executes the printer driver stored in the storage section 240 in response to a printing instruction operation performed by the user. All or a part of functions executed by the control section 250 may be performed using hardware such as an ASIC (Application Specific Integrated Circuit), a PLD (Programmable Logic Device) or an FPGA (Field Programmable Gate Array). Data of the printer driver may be recorded in a computer-readable recording medium. The recording medium is not limited to the storage section 240. The computer-readable recording medium may be, for example, a portable medium such as a flexible disk, a magneto-optical disk, a ROM (Read Only Memory), a CD-ROM (Compact Disc Read Only Memory), or the like. The computer-readable recording medium may be a storage device such as a semiconductor storage device (e.g., an SSD (Solid State Drive)), a hard disk, or the like. These storage devices are non-temporary recording media. The printer driver may be transmitted via an electric communication line.

FIG. 3 is a flowchart depicting a specific example of a flow of an operation at the time a printing setting is recorded by the information processing apparatus 200. First, the user operates the information processing apparatus 200 to input an instruction to open a file A through an application X to the information processing apparatus 200. In response to the input, the control section 250 of the information processing apparatus 200 reads out data of the application X from the storage section 240 to execute the application X. Further, the control section 250 reads out the data of the file A from the storage section 240, and enables the data of the file A to be editable through the application X (Act 101).

If the user performs an operation for printing in the image forming apparatus 100, the control section 250 reads out a printer driver corresponding to the image forming apparatus 100 from the storage section 240 in response to the operation, and starts the printer driver. The user determines a desired printing setting S1 by operating a user interface of the printer driver. If an instruction to apply the printing setting S1 from the user is received, the control section 250 applies the printing setting S1 as the printing setting for the file A being opened now, and temporarily stores the printing setting S1 (Act 102).

The user performs an operation for recording the printing setting S1 applied as the printing setting for the file A being opened now in the file A (hereinafter, referred to as a “printing setting recording operation”) as necessary (Act 103). If the printing setting recording operation is performed, the control section 250 receives the printing setting recording operation. For example, when the printing setting recording operation is performed, the control section 250 records the printing setting S1 being applied to the file A in a specified area of the data of the file A (Act 104).

The specified area does not affect the data content of the file A or the operation of the application X relating to the file A. The specified area may record, for example, properties of the file. The specified area may record data such as a specified character string among the properties. For example, the specified area may relate to an item called a tag in the properties. The printing setting S1 may be recorded as data of a character string recognizable by a person, or may be recorded as coded data that cannot be easily recognized by a person.

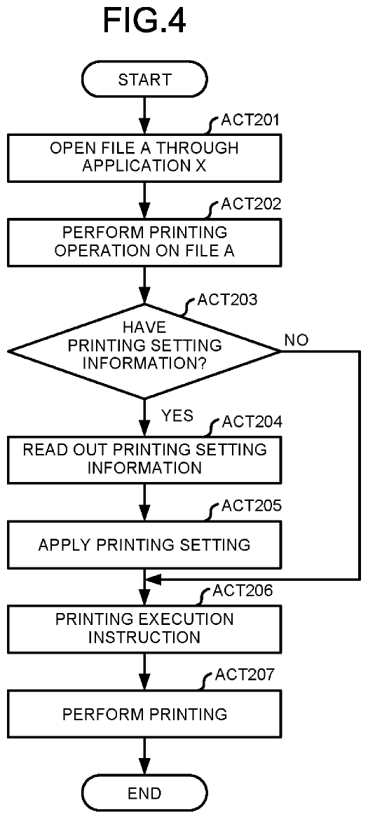

FIG. 4 is a flowchart depicting a specific example of a flow of an operation at the time printing is performed by the information processing apparatus 200. First, the user operates the information processing apparatus 200 to input an instruction to open the file A through the application X to the information processing apparatus 200. In response to the input, the control section 250 of the information processing apparatus 200 reads out data of the application X from the storage section 240 and executes the application X. Further, the control section 250 reads out the data of the file A from the storage section 240, and enables the data of the file A to be editable through the application X (Act 201).

If the user performs an operation for performing printing in the image forming apparatus 100, the control section 250 reads out the printer driver corresponding to the image forming apparatus 100 from the storage section 240 in response to the operation, and starts the printer driver. In response to the start of the printer driver, the control section 250 determines whether the printing setting information is recorded in the file A to be printed (Act 203). At this time, the control section 250 determines whether or not the printing setting information is recorded in a predetermined specified area.

If the printing setting information is recorded in the specified area (Yes in Act 203), the control section 250 reads out the recorded printing setting information (Act 204). The control section 250 applies the printing setting information read out as the printing setting for the file A being opened now (Act 205).

Thereafter, if a printing execution instruction made by the user is received (Act 206), the control section 250 prints the file A being opened now according to the applied printing setting (Act 207). In Act 207, the control section 250 instructs the image forming apparatus 100 corresponding to the used printer driver to print the file A according to the applied printing setting.

For example, the file A in which the printing setting information is recorded in the information processing apparatus 200a may be transmitted to the information processing apparatus 200b, and the file A may be printed by the image forming apparatus 100b in the information processing apparatus 200b. As described above, even if the information processing apparatus (the information processing apparatus 200a) to which the printing setting is first applied and the information processing apparatus (the information processing apparatus 200b) in which the printing is performed after that are different apparatuses, the printing is performed according to an appropriate printing setting based on the printing setting information recorded in the file A.

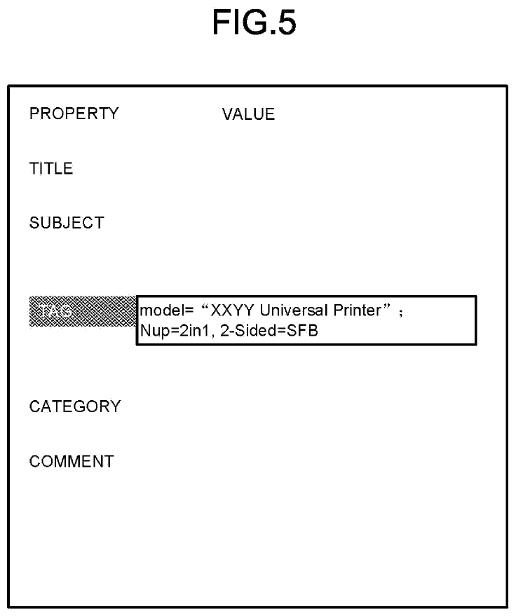

FIG. 5 is a diagram illustrating a specific example of the printing setting information. In the example shown in FIG. 5, “Model=“XXYY Universal Printer”; Nup=2in1, 2-Sided=SFB” is recorded as a value of the tag in the properties.

According to the system configured as described above, the printing setting set by the user is recorded in the data of the file. If the user intends to print the file in which the printing setting is recorded in another environment, the printing setting is read out by the printer driver to be applied to the file. Therefore, the printing can be easily performed in different information processing apparatuses (information processing apparatuses 200) or different printers (image forming apparatuses 100) according to the printing setting applied by the user once. Since the printing setting information is recorded in the data of the file to be printed, it is not necessary to handle the file to which the printing setting information is exported.

### (Modification)

In the flowchart shown in FIG. 4, the printing is performed according to the printing setting applied in Act 205 without any change. However, the printing may be performed after the printing setting applied in Act 205 is further changed through a subsequent operation by the user. Even in such a configuration, the user can change the printing setting based on the printing setting already recorded, and thus there is no need to perform the printing setting from the start. Therefore, the burden in labor required for the printing setting can be reduced.

The printing setting recorded as the printing setting information may be a printing setting that cannot be applied in the printer driver and the image forming apparatus 100 at that time point in some cases. In such a case, the control section 250 may discard the printing setting that cannot be applied among the recorded printing settings and perform the printing according to a default setting. The control section 250 may output characters or an image indicating that the recorded printing setting cannot be applied in the current environment from the output section 220 to the user. The control section 250 may perform the printing by applying other printing settings applicable in the current environment instead. In this case, a substitute table in which each printing setting and a printing setting to be applied instead are associated in advance may be used. Such a substitute table may be stored in the storage section 240 together with the printer driver.

While certain embodiments have been described, these embodiments have been presented by way of example only, and are not intended to limit the scope of the invention. Indeed, the novel embodiments described herein may be embodied in a variety of other forms; furthermore, various omissions, substitutions, and changes in the form of the embodiments described herein may be made without departing from the spirit of the invention. The accompanying claims and their equivalents are intended to cover such forms or modifications as would fall within the scope and spirit of the invention.

1. A method for providing settings in a printing operation from a printer driver installed in an information-processing device to an image forming apparatus, the method comprising:
opening a file for editing with an application;
starting the printer driver;
applying printing setting information operable to configure the image forming apparatus to print data of the file by the printer driver;
recording the printing setting information in a data area in the file by the application, wherein the recorded printing setting information is transferrable together with the file and does not affect the data of the file when the file is run in an application; and
instructing the image forming apparatus by the printer driver to print the file according to the printing setting information set by the printer driver.

2. The method of claim 1, wherein recording the printing setting information comprises recording data related to properties of the file.

3. The method of claim 1, wherein the printing setting information is operable to configure a second image forming apparatus different from the image forming apparatus to print the data of the file.

4. The method of claim 3, wherein recording the printing setting information comprises recorded instructions indicating at least one of a size or an orientation of a sheet to be printed.

5. The method of claim 1, wherein recording the printing setting information comprises recorded instructions indicating at least one of color, a number of pages per sheet, or a selection of duplex mode.

6. The method of claim 1, wherein recording the printing setting information comprises recorded instructions indicating a portion of the data of the file to be printed.

7. The method of claim 6, wherein the portion of the data of the file is confidential information.

8-16. (canceled)

17. A printing system comprising:
an image forming apparatus operable to perform a printing task; and
an information processing device communicably connected to the image forming apparatus, the information processing device including a memory configured to store a printer driver and a processor configured to:
execute the printer driver to apply setting information operable to configure the image forming apparatus to print data of a file,
structurally arrange the file to include the data to be printed and a separate data area for storing the setting information, the setting information editable and isolated from the data to be printed, and
send the file to the image forming apparatus as a subject for the printing task to be printed according to the setting information set by the printer driver.

18. (canceled)

19. The printing system of claim 17, wherein the setting information includes instructions indicating a size and an orientation of a sheet to be printed by the image forming apparatus.

20. The printing system of claim 17, wherein the setting information includes instructions indicating at least one of color, a number of pages per sheet, or a selection of duplex mode for the printing task to be performed by the image forming apparatus.
